(19) United States
(12) Patent Application Publication
(10) Pub. No.: US 2018/0236658 A1
(43) Pub. Date: Aug. 23, 2018

(54) Assembly System and Method For Inserting a Terminal Into a Housing

(71) Applicants: Tyco Electronics (Shanghai) Co. Ltd., Shanghai (CN); TE Connectivity Corporation, Berwyn, PA (US)

(72) Inventors: Yingcong Deng, Shanghai (CN); Lvhai Hu, Shanghai (CN); Dandan Zhang, Shanghai (CN); Roberto Francisco-Yi Lu, Berwyn, PA (US); Eldeeb Yasser, Berwyn, PA (US)

(73) Assignees: Tyco Electronics (Shanghai) Co. Ltd., Shanghai (CN); TE Connectivity Corporation, Berwyn, PA (US)

(21) Appl. No.: 15/957,288

(22) Filed: Apr. 19, 2018

Related U.S. Application Data
(63) Continuation of application No. PCT/EP2016/071070, filed on Sep. 7, 2016.

(30) Foreign Application Priority Data
Sep. 7, 2015 (CN) 201510561544.X

(51) Int. Cl. B25J 9/16; B25J 9/00; B25J 9/04

(52) U.S. Cl. CPC B25J 9/1623; B25J 9/0069; Y10S 901/08; B25J 9/046; B25J 9/1687; B25J 9/009

(57) ABSTRACT

An assembly system for inserting a terminal into a housing comprises a parallel robot mechanism, a serial robot mechanism, and an insertion mechanism. The parallel robot mechanism has a support platform on which the housing is held and a plurality of joints. The serial robot mechanism has an end effector connected to the support platform and is adapted to drive the parallel robot mechanism to move. The insertion mechanism is configured to insert the terminal into the housing. The parallel robot mechanism is moved by the serial robot mechanism to an insertion position in which an insertion hole of the housing is aligned with the terminal prior to the insertion mechanism inserting the terminal into the housing. At least a portion of the plurality of joints are locked while the insertion mechanism inserts the terminal into the housing to keep the parallel robot mechanism and the support platform stationary.

### CROSS-REFERENCE TO RELATED APPLICATIONS

This application is a continuation of PCT International Application No. PCT/EP2016/071070, filed on Sep. 7, 2016, which claims priority under 35 U.S.C. § 119 to Chinese Patent Application No. 201510561544.X, filed on Sep. 7, 2015.

### FIELD OF THE INVENTION

The present invention relates to an assembly system and, more particularly, to an assembly system adapted to insert a terminal into a housing.

### BACKGROUND

Assembly of a product, as is generally known, is usually completed by a plurality of robots. The robots are capable of accurately and rapidly assembling a plurality of micro-parts to form the product. Two robots, for example, may cooperate to insert a terminal into a housing to form an electrical device such as a connector.

In order for two robots to insert a first member into a second member, a first robot grips the first member, a second robot grips the second member, and the first robot then moves the first member relative to the second robot to insert the first member into the second member. This form of assembly works well when a small insertion force is required to insert the first member into the second member.

Robots, however, have low rigidity and cannot bear a large operation force. If the insertion force required for inserting the first member into the second member is large, the positional accuracy of the robot is difficult to control, which may reduce the precision of the assembly. For example, a large insertion force is required to insert a terminal into a housing in an interference fitting manner. If the large insertion force is directly exerted on end effectors of the two robots, the two robots will not be able to reliably maintain the relative position between the terminal and the housing, reducing the assembly precision of the terminal in the housing.

### SUMMARY

An assembly system for inserting a terminal into a housing comprises a parallel robot mechanism, a serial robot mechanism, and an insertion mechanism. The parallel robot mechanism has a support platform on which the housing is held and a plurality of joints. The serial robot mechanism has an end effector connected to the support platform and is adapted to drive the parallel robot mechanism to move. The insertion mechanism is configured to insert the terminal into the housing. The parallel robot mechanism is moved by the serial robot mechanism to an insertion position in which an insertion hole of the housing is aligned with the terminal prior to the insertion mechanism inserting the terminal into the housing. At least a portion of the plurality of joints are locked while the insertion mechanism inserts the terminal into the housing to keep the parallel robot mechanism and the support platform stationary.

### BRIEF DESCRIPTION OF THE DRAWINGS

The invention will now be described by way of example with reference to the accompanying Figures, of which:

FIG. 1 is a schematic side view of an assembly system according to an embodiment.

### DETAILED DESCRIPTION OF THE EMBODIMENT(S)

Exemplary embodiments of the present invention will be described hereinafter in detail with reference to the attached drawings, wherein like reference numerals refer to like elements. The present invention may, however, be embodied in many different forms and should not be construed as being limited to the embodiments set forth herein. Rather, these embodiments are provided so that the present disclosure will be thorough and complete and will fully convey the concept of the disclosure to those skilled in the art.

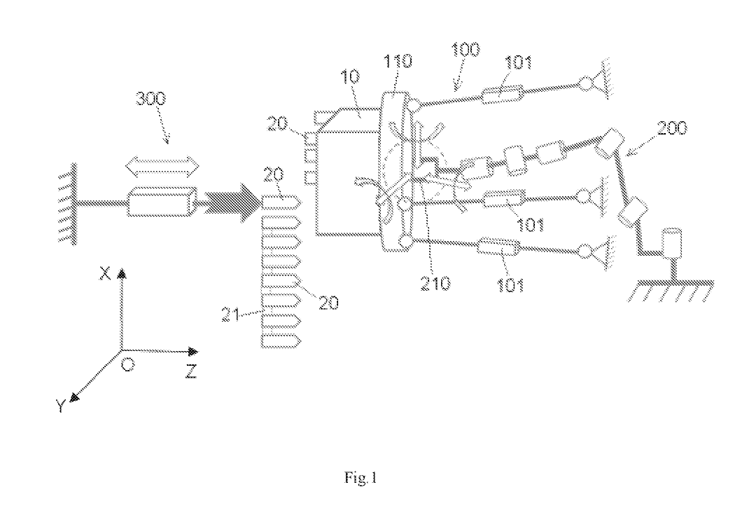

An assembly system according to an embodiment is shown in FIG. 1 and is adapted to insert a terminal 20 into a housing 10 to form an electrical device. In an embodiment, the electrical device is a connector and the terminal 20 is a metal terminal inserted into an insulative housing 10 to form the connector. The assembly system comprises a parallel robot mechanism 100, a serial robot mechanism 200, and an insertion mechanism 300 as shown in FIG. 1.

The parallel robot mechanism 100 has a support platform 110. The housing 10 is fixed and held on the support platform 110 such that the housing 10 is moved with the support platform 110. In an embodiment, the parallel robot mechanism 100 has multiple degrees of freedom. In the embodiment shown in FIG. 1, the parallel robot mechanism 100 is movable in at least one of a first direction X, a second direction Y, and a third direction Z that are perpendicular to each other. In an embodiment, the parallel robot mechanism 100 is further configured to be rotatable about at least one of the first direction X, the second direction Y and the third direction Z.

The serial robot mechanism 200 has an end effector 210 connected to the support platform 110. The serial robot mechanism 200 is adapted to drive the parallel robot mechanism 100 to move via the end effector 210. In an embodiment, the serial robot mechanism 200 is a multi-axis robot with multiple degrees of freedom. In the embodiment shown in FIG. 1, the serial robot mechanism 200 is a six-axis robot. In other embodiments, the serial robot mechanism 200 may be a four-axis or five-axis robot.

The insertion mechanism 300 is configured to insert the terminal 20 into an insertion hole of the housing 10 held on the support platform 110. In an embodiment, the insertion mechanism 300 includes a fixture and a moving mechanism. The fixture is adapted to clamp the terminal 20 to be inserted and the moving mechanism is adapted to insert the clamped terminal 20 into the insertion hole of the housing 10. In another embodiment, the insertion mechanism 300 includes an injection mechanism adapted to inject the terminal 20 into the insertion hole of the housing 10. In further embodiments, the insertion mechanism 300 may be any insertion mechanism known to those with ordinary skill in the art and capable of inserting the terminal 20 into the housing 10; for example, the insertion mechanism 300 may alternatively be a multi-axis robot.

The parallel robot mechanism 100 is moved by the serial robot mechanism 200 until the insertion hole in the housing 10 is aligned with the terminal 20 to be inserted in an insertion position. The parallel robot mechanism 100 and the support platform 110 are kept stationary in the insertion position by locking at least a portion of a plurality of joints 101 of the parallel robot mechanism 100. The joints 101 are parts of arms of the parallel robot mechanism 100 which connect the support platform 110 to a stationary surface. The joints 101 are locked prior to and during insertion of the terminal 20 into the housing 10 by the insertion mechanism 300. The locking of the joints 101 increases the rigidity of the parallel robot mechanism 100. An insertion force required for inserting the terminal 20 into the housing 10 is completely exerted on and then borne by the parallel robot mechanism 100 with high rigidity, rather than being exerted on the serial robot mechanism 200 having a low rigidity. The positional accuracy of the housing 10 moved by the serial robot mechanism 200 is thereby ensured, improving the assembly precision of the terminal 20 in the housing 10.

In an embodiment, the assembly system further comprises a transmission mechanism and a cutting mechanism. The transmission mechanism is adapted to transmit a terminal material strip 21 shown in FIG. 1 to the insertion mechanism 300. The cutting mechanism is adapted to cut the terminal 20 out of the terminal material strip 21, which has been transmitted to the insertion mechanism 300. In such an embodiment, the insertion mechanism 300 may comprise a manipulator adapted to grip the terminal 20 cut out of the terminal material strip 21 and insert the gripped terminal 20 into the insertion hole of the housing 10.

A process of inserting the terminal 20 into the housing 10 will now be described in greater detail with reference to FIG. 1.

First, as shown in FIG. 1, the housing 10 is mounted and held on the support platform 110 of the parallel robot mechanism 100. In various embodiments, the housing 10 may be directly fixed on the support platform 110 or fixed by a fixture mounted on the support platform 110.

The terminal material strip 21 is then fed to the insertion mechanism 300 by the transmission mechanism.

The terminal 20 is then cut out of the terminal material strip 21 by the cutting mechanism.

The cut terminal 20 is then held to be inserted on the insertion mechanism 300.

The parallel robot mechanism 100 is then driven to move by the serial robot mechanism 200 to an insertion position in which the insertion hole in the housing 10 is aligned with the terminal 20 to be inserted.

At least a portion of the plurality of joints 101 of the parallel robot mechanism 100 are then locked so that the parallel robot mechanism 100 and the support platform 110 are kept stationary.

The terminal 20 is then inserted into the insertion hole of the housing 10 by the insertion mechanism 300.

In an embodiment, a plurality of terminals 20 are each inserted into different insertion holes of the housing 10. In this embodiment, after the first terminal 20 is inserted into the housing 10, the joints 101 are unlocked so that the parallel robot mechanism 100 and the support platform 100 are movable again. The above process is then repeated for each of the different insertion positions until each of the plurality of terminals 20 is inserted into the housing 10.

What is claimed is:

1. An assembly system for inserting a terminal into a housing, comprising:
a parallel robot mechanism having a support platform on which the housing is held and a plurality of joints;
a serial robot mechanism having an end effector connected to the support platform, the serial robot mechanism adapted to drive the parallel robot mechanism to move via the end effector; and
an insertion mechanism configured to insert the terminal into the housing, the parallel robot mechanism is moved by the serial robot mechanism to an insertion position in which an insertion hole of the housing is aligned with the terminal prior to the insertion mechanism inserting the terminal into the housing, at least a portion of the plurality of joints are locked while the insertion mechanism inserts the terminal into the housing to keep the parallel robot mechanism and the support platform stationary.

2. The assembly system of claim 1, wherein the parallel robot mechanism has multiple degrees of freedom.

3. The assembly system of claim 2, wherein the parallel robot mechanism is movable in at least one of a first direction, a second direction, and a third direction that are perpendicular to each other.

4. The assembly system of claim 3, wherein the parallel robot mechanism is rotatable about at least one of the first direction, the second direction, and the third direction.

5. The assembly system of claim 4, wherein the serial robot mechanism has multiple degrees of freedom.

6. The assembly system of claim 5, wherein the serial robot mechanism is a multi-axis robot.

7. The assembly system of claim 1, further comprising a transmission mechanism adapted to transmit a terminal material strip to the insertion mechanism.

8. The assembly system of claim 7, further comprising a cutting mechanism adapted to cut the terminal out of the terminal material strip.

9. The assembly system of claim 8, wherein the insertion mechanism includes a manipulator adapted to grip the terminal cut out of the terminal material strip and insert the gripped terminal into the insertion hole of the housing.

10. The assembly system of claim 1, wherein the insertion mechanism includes a fixture adapted to clamp the terminal and a moving mechanism adapted to insert the terminal into the insertion hole of the housing.

11. The assembly system of claim 1, wherein the insertion mechanism includes an injection mechanism adapted to inject the terminal into the insertion hole of the housing.

12. The assembly system of claim 1, wherein the plurality of joints are parts of arms of the parallel robot mechanism which connect the support platform to a stationary surface.

13. A method of assembling a terminal and a housing, comprising:
providing an assembly system including a parallel robot mechanism having a support platform and a plurality of joints, a serial robot mechanism having an end effector connected to the support platform, and an insertion mechanism;
holding the housing on the support platform;
holding the terminal on the insertion mechanism;
moving the parallel robot mechanism using the serial robot mechanism into an insertion position in which an insertion hole of the housing is aligned with the terminal;
locking at least a portion of the plurality of joints of the parallel robot mechanism to keep the parallel robot mechanism and the support platform stationary; and
inserting the terminal into the insertion hole of the housing using the insertion mechanism.

14. The method of claim 13, wherein each of a plurality of terminals is inserted into one of a plurality of insertion holes of the housing.

15. The method of claim 14, further comprising unlocking the plurality of joints so that the parallel robot mechanism and the support platform are movable.

16. The method of claim 15, wherein the moving, locking, inserting, and unlocking steps are repeated until each of the plurality of terminals is inserted into the housing.
